(19) United States
(12) Patent Application Publication
(10) Pub. No.: US 2025/0205952 A1
(43) Pub. Date: Jun. 26, 2025

(54) METHOD AND DEVICE FOR DETERMINING THE WEAR ON A DEVICE FOR PROCESSING PLASTICS

(71) Applicant: ARBURG GMBH + CO KG, Loßburg (DE)

(72) Inventors: Werner FAULHABER, Lossburg Wittendorf (DE); Philipp KLOKE, Baiersbronn Obertal (DE)

(21) Appl. No.: 18/836,199

(22) PCT Filed: Feb. 15, 2023
(86) PCT No.: PCT/EP2023/053767

§ 371 Date: Aug. 6, 2024

(30) Foreign Application Priority Data
Feb. 15, 2022 (DE) 10 2022 103 483.6

(51) Int. Cl. B29C 45/84

(52) U.S. Cl. CPC B29C 45/84; B29C 2945/76949

(57) ABSTRACT

A method for a device for processing plastics and other plasticisable compounds by a cyclical or continuous processing procedure, a device using the method, and a computer program product for carrying out the method, by means of which the wear of individual module components or modules of the device and thus of the device as a whole can be determined in order to facilitate the maintenance of the module components or modules of the device and thus of the device as a whole, to improve the availability for use thereof and to increase the service life thereof.

### REFERENCE TO RELATED APPLICATIONS

The present application relates to and claims the priority from German patent application 10 2022 103 483.6, filed on 15 Feb. 2022, the disclosure of which is hereby expressly, in its entirety, made part of the subject matter of the present application.

### TECHNICAL FIELD

The disclosure relates to a method for determining the wear on at least one module of a device for processing plastics and other plasticisable materials by a cyclical or continuous processing procedure and a device for processing plastics and other plasticisable materials by a cyclical or continuous processing procedure for determining wear on at least one module of the device. The disclosure also relates to a computer program product.

### BACKGROUND

DE 10 2016 009 114 B4 discloses a fault cause diagnostic device for an injection moulding machine, which is capable of predicting an impending fault cause and/or an impending fault with a high degree of reliability independently of the knowledge and experience of analysts. The fault cause diagnostic device for detecting a fault operates on the basis of an input of internal and external status variables by means of a machine learning device for supervised learning. Therein, the internal and external status variables comprise information relating to the occurrence of a fault and at least one information item relating to a load on a drive unit of the injection moulding machine, a frequency response of an axis, a resin pressure, a clamping force of a mould, an alarming history, a machine operation run, process monitoring data for each injection moulding cycle, injection moulding conditions and/or quality information regarding an injection moulding. As a result of the learning process for supervised learning, the machine learning device stores an internal parameter which has been obtained by the machine learning device using the status variables obtained during the detection of a fault, if no fault has been ascertained. The machine learning device further uses, as learning data, a set from the status variables for each start of an injection moulding process and an alarm or fault status during learning. However, the fault cause diagnostic device relies on the inclusion of previously occurring faults for its prediction, by means of which the machine learning device is initially enabled to predict faults on the basis of the supervised learning algorithm.

DE 101 61 633 A1 discloses a method for providing an estimate of a virtual age for the prediction of the remaining service life of any device of a given type. The method comprises the steps: monitoring a predetermined number of significant parameters of respective devices of a training set of devices of the specified type, wherein the parameters each contribute wear increments, ascertaining coefficients of a neural network with a radial basis function for modelling the wear increments that are ascertained from the training set which is operated until failure and the virtual ages of which are substantially normalised to a desired normal value, deriving a formula for the virtual age of a device of the given type from the neural network with a radial basis function, and applying the formula to the significant parameters from a further device of the given type to derive wear increments for the further device. The method uses a series of comparable test devices and a neural network, taking account of significant parameters of the test devices and a normalised age for calculating an actual age and/or a residual service life of a specific device. The actual age and/or the remaining service life of the specific device is estimated on the basis of comparative data.

DE 10 2016 008 750 A1 discloses a method for estimating an expected service life of a component of an arbitrary machine, wherein in the method, process data from the machine which during execution of a cyclical operation step is acquired by the machine is recorded, the acquired data is transferred to a database, the data placed in the database is analysed for failure patterns according to a failure pattern catalogue, in order to estimate the expected lifespan of the component, and a notification is output if a recognised failure pattern is found in the analysed data. A comparison takes place with previously ascertained data from a database which contains failure patterns from reference components in order to estimate the expected service life of the specific component.

From DE 10 2020 102 370 A1, a method relating to machine learning in a status determining device for determining an operating status of an industrial machine such as an injection moulding machine is known. The status determining method comprises the following: a data acquisition step for obtaining data on the industrial machine; a learning data extraction step for extracting data which is used for processing in relation to machine learning from the data that is obtained from the industrial machine, from the data that is obtained in the data acquisition step, according to an extraction condition for extracting the data that is used for processing in relation to the machine learning; and a step of carrying out the processing in relation to the machine learning using the data which is extracted in the learning data extraction step. The method serves for the improvement of machine learning, in order to obtain more exact data regarding the operating status of the machine.

### BRIEF SUMMARY

The disclosure provides a method for a device for processing plastics and other plasticisable materials by means of a cyclical or continuous processing procedure, a device and a computer program product for carrying out the method, by means of which the wear on individual module components and/or modules of the device and therefore on the device as a whole can be determined without predetermined comparison models, in order to facilitate the servicing of the module components and/or the modules of the device and thus of the device as a whole, to improve its operational readiness and to extend its service life.

By means of the method respectively its application in a device for processing plastics and other plasticisable materials by means of a cyclical or continuous processing procedure, advantageously the servicing of the module components respectively of the modules of the device and therefore of the device as a whole is facilitated, its operational readiness is improved and its service life is extended. In particular, by means of the method, recommendations can be output in good time with regard to the servicing or exchange of individual module components or complete modules in which either an exchange with equivalent module components respectively modules or an exchange with higher quality and/or more efficient module components respectively modules is proposed if they are, for example, worn and/or if thereby the productivity of the device, the service life of individual module components or of complete modules can be enhanced.

In comparison with the prior art, what is achieved thereby is that module components respectively modules can be serviced or exchanged as soon as a deteriorating part quality is recognised and/or before their complete failure. In the previous approaches from the prior art, the module components respectively modules are exchanged either after the expiry of a predetermined time or only on occurrence of a defect, whereby higher costs are incurred through the early exchange of still usable module components respectively modules and more rejected parts arise.

For this purpose, at least one exchangeable module, each with a control unit (and communications interfaces between the control units) are used in order, using technical parameters, to carry out the steps of the method, also, where relevant, repeatedly. Therefrom, recommended actions for the further operation of the device are derived.

Advantageous developments are the subject matter of the dependent claims.

In a preferred embodiment of the method, the wear is determined for at least one of the modules comprising a plasticising module, a drive module, a material output module, a material feed module and a mold module/object carrier module. By this means advantageously, account can be taken of the circumstance that dependent upon the purpose of use, individual, or a plurality of, modules can be subject to particular attention, for example, in order to operate energy-efficiently.

In order, advantageously, to make the results of the evaluation accessible by means of a human-machine interface to an operator in a good and user-friendly manner, in a preferred further exemplary embodiment, the analysis and action recommendation can be output and/or visualised in a display device.

Preferably, in an embodiment of the method, the communications interfaces of the at least one module and of the device can transmit data wirelessly in order to reduce the production effort at the machine. Also possible are bus connections which connect the modules and the device to one another in a simple manner for communication, possibly even in real time.

In order, advantageously, to facilitate the implementation of the method and, in particular, the determination of the wear parameter data and their evaluation, preferably in one exemplary embodiment of the method, from the module data and the weighted process parameter data, an equivalent stress of at least one of the module components is ascertained and used as a wear parameter datum.

In order that the information gathered is advantageously more readily accessible for further applications and that thereby wear data are reliably determinable, according to one embodiment of the method, the wear parameter data are converted into status variables and transferred into an input layer of a trained device for machine learning, wherein preferably the device for machine learning outputs the analysis and action recommendation.

Preferably, for the observation and determination of the wear, the following process parameter data, in particular, which are advantageously capable of providing information regarding the loading on the respective module, come into consideration: a counter value, a mean value, a maximum and minimum value, a cycle-weighted mean value, a work integral, an injecting pressure, a holding pressure, a back pressure, a torque, a rotary speed, a loading value, an equivalent stress of an extruder shaft, in particular, a screw shaft, and/or of at least one drive shaft, an equivalent stress which is ascertained from a loading during injection, during the holding pressure or during the dosing, a screw travel, a closing force of the mold, a target and actual position and a target and actual speed of the mold or the object carrier, a target and actual pressure of the plasticising module, a droplet size or a mass volume of the material output module, a number of fibre strands fed in, an elastic constant of the fibre strands, a density distribution of the fibre strands, a material characteristic value of the currently processed material or of a plasticisable material of the material feed module, time, time periods, time sequences or an energy usage value of a heating system or a mechanical system. Further process parameter data are not precluded, provided they can be related to a wear.

Preferably, a handling module with a control unit on the material feed module is used for handling the plasticisable material and/or a handling module with a control unit on the mold module/object carrier module is used for handling a plasticised material and components, in order thereby, advantageously, to subject the material and/or components, for example, to an automatic or manual evaluation. By means of a quality evaluation, possibly additional conclusions can be drawn from the produced components regarding the wear of the at least one module.

The method is preferably also suitable to be carried out on a plurality of machines and thereby, in particular, with identical machine configurations, identical processes and/or identical materials that are to be processed, to form and evaluate clusters. By means of the increased quantity of module data and/or weighted process parameter data and/or wear parameter data and/or analysis and action recommendations thereby obtained, a reliable assessment of wear and, associated therewith, recommendations for action, including for other machines and/or users can advantageously be obtained. The evaluation models can thus be further enhanced, which also contributes to the production of qualitatively high value components. The machine operator can roll out an algorithm generated in this way from his “model factory” to other production locations and obtains the same good product quality everywhere with simultaneous knowledge protection.

Preferably, the algorithms generated in this way can also be made available, at least in extracts, to the machine manufacturer, so that advantageously with information of this type, the conditions for a reliable evaluation and prediction of wear can be enhanced.

The disclosure as set out is also achieved with a device for processing plastics and other plasticisable materials, which is equipped, configured and/or constructed to carry out the method.

The disclosure is also achieved by means of a corresponding computer program product with a program code which is stored on a computer-readable medium and is suitable for carrying out the method.

The features set forth individually in the claims are combinable in a technically useful manner and can be enhanced with explanatory facts from the description and details from the drawings, wherein further variants are disclosed.

### BRIEF DESCRIPTION OF THE DRAWINGS

The disclosure will now be described in greater detail by reference to an exemplary embodiment illustrated in the accompanying drawings. In the drawings:

FIG. 1 shows a device with exchangeable modules, which functions in accordance with an additive processing procedure,

FIG. 2 shows a device with exchangeable modules, which functions in accordance with an injection moulding process,

FIG. 3 shows a flow diagram of individual method steps,

FIG. 4 shows a schematic diagram of a process enhancement.

### DETAILED DESCRIPTION OF PREFERRED EXEMPLARY EMBODIMENTS

The disclosure will now be described in greater detail using examples, making reference to the accompanying drawings. The exemplary embodiments merely represent examples which, however, are not intended to restrict the inventive concept to a particular arrangement. Before the disclosure is described in detail, it should be noted that it is not restricted to the various components of the device and the various method steps, since these components and methods can vary. The expressions used herein are intended merely to describe particular embodiments and are not used restrictively. Furthermore, where the singular or the indefinite article is used in the description or the claims, it also relates to a plurality of these elements, provided the overall context does not clearly reveal otherwise.

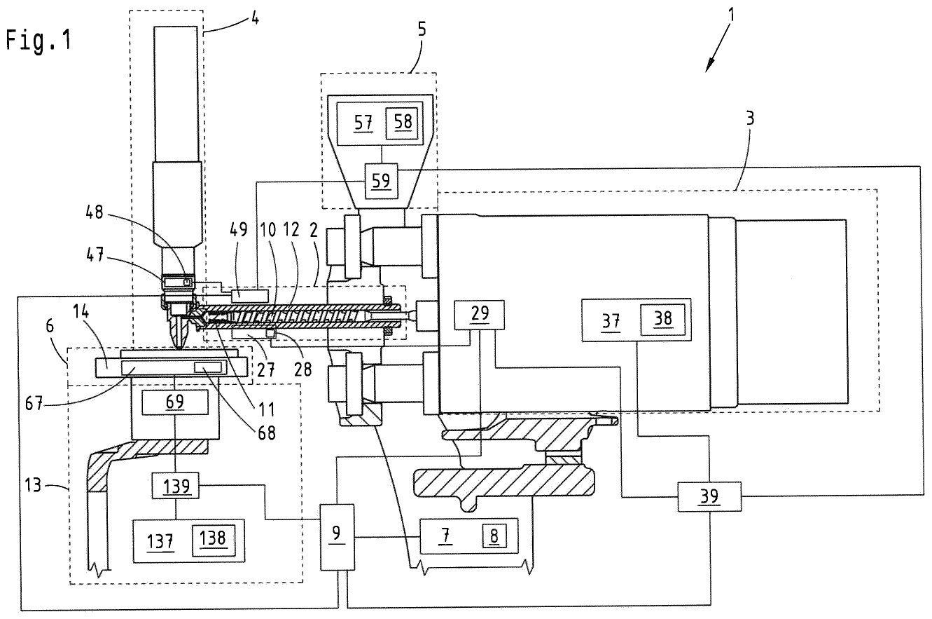

The embodiment of the device 1, as shown in FIG. 1, for processing plastics and other plasticisable materials with a cyclical or continuous processing procedure, with exchangeable modules, which functions according to an additive processing procedure, comprises communications interfaces 9, 29, 39, 49, 59, 69, 139 between a control unit 7 of the device 1 and at least one control unit 27, 37, 47, 57, 137 of a plasticising module 2, a drive module 3, a material output module 4, a material feed module 5 and a mold module/object carrier module 6.

The expression “plasticisable material” should herein be understood broadly and comprises, in particular but not only, apart from the plastics materials mentioned, for example, ceramic, metallic and/or powdered materials as well as paper, cellulose, starch, cork, etc. and also material mixtures between such plasticisable materials. In principle, the method is also applicable to previously plasticised materials or plastic masses which harden after application, automatically or with the use of auxiliary agents.

A cyclical or continuous processing procedure should be understood, in particular, to mean already known processing procedures such as, for example, additive methods for producing components, with which a plasticisable material is applied, for example, drop-wise, that is cyclically, or as a continuous strand, wherein the component is produced piece by piece or, for example, injection moulding processes in which the plasticisable material, such as plastics, is injected into a mould cavity of an injection moulding tool.

In this regard, the connections between the control unit 7 of the device 1 and the control units 27, 37, 47, 57, 137 of the modules 2, 3, 4, 5, 6 can be created either directly or indirectly with modules 2, 3, 4, 5, 6 interposed therebetween. Each of the modules 2, 3, 4, 5, 6 is exchangeable within the device 1, so that with increasing wear on individual modules 2, 3, 4, 5, 6, 13, they can easily be removed and replaced. This is a significant advantage over conventional devices of this type in which previously either no module change is possible or a removal of a module 2, 3, 4, 5, 6, 13 takes place after a particular previously defined time of operation regardless of the actual wear status of the module 2, 3, 4, 5, 6, 13. In this way, the servicing of the module components and/or of the modules 2, 3, 4, 5, 6, 13 of the device 1, and thus overall of the device 1, is facilitated, its operational readiness is improved and depending upon the loading and demands placed on the respective modules, their service life is increased proportionately.

The procedure will now be described using a plasticising module 2 of an injection moulding machine as an example, also for other modules. During the injection moulding process, a screw shaft 10 is moved in a plasticising cylinder 12 of a plasticising module 2. By means of the rotation of the screw shaft 10 in the plasticising cylinder, plasticisable material is plasticised, homogenised and dosed in front of the screw shaft, in order by means of a subsequent axial stroke of the screw shaft 10, to inject the material into the mould cavity of an injection mould accommodated in a mould closing unit in which the component is formed. The relative movement between the plasticising cylinder 12 and the screw shaft 10 on rotation and axial movement of the screw shaft leads over time to wear on both the components plasticising cylinder 12 and screw shaft 10, which however depends both upon the material and the quality of these components as well as on the material to be processed and its properties.

In principle, the service lives of the plasticising cylinder 12, the backflow check valve 11 and the screw shaft 10 are per se known, but if a plasticising module 2 is continuously subjected to an operating point at a capacity utilisation rate of 100%, that is at the maximum possible loading and the maximum possible throughput, this leads to a different service life than if the capacity utilisation were only 70% or even 50%. Likewise, a material that is abrasive and/or provided with additives such as fibres or ceramic particles leads to a faster wear than a non-abrasive material. For the materials also, material characteristic values or material classes are available which enable access to an assessment of a wear level and/or a prediction of a service life. Also included, however, are operating data such as the cycle time or the cycle count. However, all this information also includes empirical values or statistical data on the operation of such devices 1.

All these data are used to generate analysis and action recommendations. Thus, for example, the capacity utilisation rate is integrated over time and multiplied by a factor representing the abrasiveness of the material or the material class. This calculation model can be compared with reality in that, for example, an assessment of the components of the module or the device 1 or an evaluation of the components produced takes place.

The analysis and action recommendations include, for example, the indication from the device that with this plasticising module 2—to remain with the example—the desired part count can no longer be produced or that 70% of the maximum service life to be expected for the module has already been reached. The action recommendation can also state that it would be better not to process this (abrasive) material with this feed screw and/or screw shaft 2 and that another feed screw is already in the stores or can be ordered from the manufacturer, i.e. it can also involve modification recommendations. If a plurality of machines is also included in the machinery park, the recommendation can also be that under these conditions it is better to produce this component on another machine.

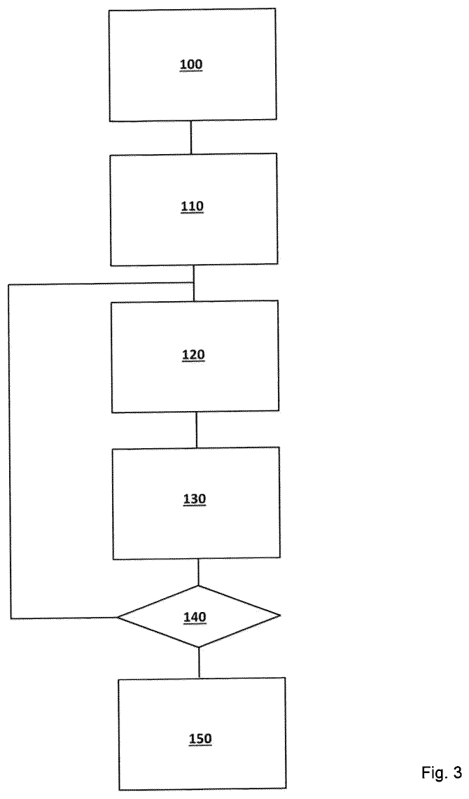

The method according to the disclosure will now be described in greater detail using a method sequence represented in FIG. 3. In a first method step 110, it comprises providing module data, which comprise information regarding module components used, in a data store 28, 38, 48, 58, 138 of the at least one module 2, 3, 4, 5, 6, 13. These module data are sent by means of the control unit 27, 37, 47, 57, 137 of the at least one module 2, 3, 4, 5, 6, 13 to the control unit 7 of the device 1 for storage in a data store 8 of the device 1. The module data can be stored in the data store 28, 38, 48, 58, 138 of the at least one module 2, 3, 4, 5, 6, 13 for example as early as during the manufacturing of the module 2, 3, 4, 5, 6, 13, but additionally or alternatively, they can also be acquired and stored during operation of the module, so that they are updated during operation.

For example, it is conceivable to acquire capacity utilisation parameters, cycle count, operating duration, operating point, material characteristic values, etc., in the control unit of the respective module or in the control unit 7 of the device 1 and to write them cyclically back into the relevant module. They then (also) “belong” to the module and thus move with it from machine to machine. Also conceivable is the reverse route. The data are acquired in the module and are written cyclically into the control unit. It is also conceivable that, on exchange of individual components, for example a screw shaft 10, data already acquired remains with the screw shaft.

In a second method step 120, a cyclical acquisition and storage of process parameter data, which comprise process-specific and/or material-specific information, in the data store 28, 38, 48, 58, 138 of the at least one module 2, 3, 4, 5, 6, 13 takes place during the processing procedure. Process-specific information is process parameters such as, for example, temperature or speed or throughput.

However, the process parameter data, or better, data that have an influence on the process also include, for example, material characteristic values or material classes. Dependent upon its composition, the material to be processed sometimes has a significant influence on the wear if it involves, for example, abrasive substances, corrosive substances and/or ceramic materials. Additives such as rock powder, colouring agents or fibres can also be or become mixed into the materials and also have an influence on the wear, in particular, of the components that come into contact with the material, for example, the screw shaft 10, the plasticising cylinder 12, the output nozzle or shut-off nozzle.

The specific energy consumption of a heating system, a specific module or a mechanism is also a process parameter value since this energy consumption is, for example, proportional to an operating point. If a well-adjusted operating point is departed from, the energy consumption usually rises. If wear increases, the energy consumption usually also increases.

The process parameter data are then weighted with a capacity utilisation value and/or a cycle count and/or an operating duration of the module 2, 3, 4, 5, 6, 13. The thus weighted process parameter data are firstly stored in the data store 28, 38, 48, 58, 138 of the at least one module 2, 3, 4, 5, 6, 13 by the control unit 27, 37, 47, 57, 137 of the at least one module 2, 3, 4, 5, 6, 13 and are additionally sent by the control unit 27, 37, 47, 57, 137 to the control unit 7 of the device 1 for storage in the data store 8 of the device 1.

In this case, “cyclical acquisition and storage” should be understood as the repeated discrete, that is for example, clock-driven or event-driven, acquisition and storage of the aforementioned process parameter data. Weighting should be understood to mean the correlating of the process parameter data with a capacity utilisation value and/or a cycle count and/or an operating duration of the module 2, 3, 4, 5, 6, 13.

In the case, for example, of an evaluation of process parameter data dependent upon the capacity utilisation rate of the device 1, for a generally medium capacity utilisation of the device 1, for example, a high level of wear of a module component or of a module 2, 3, 4, 5, 6, 13 is to be evaluated differently than for full capacity utilisation. Given a medium capacity utilisation, a high level of wear of a module component or a module 2, 3, 4, 5, 6, 13 could lead, for example, to an exchange recommendation for a more efficient module component or a module 2, 3, 4, 5, 6, 13. Given a high capacity utilisation, however, this could lead to an exchange recommendation for a higher quality module component or a module 2, 3, 4, 5, 6, 13. Capacity utilisation rate should be understood to mean the capability of the device 1 to produce a particular quantity of components per unit time at a defined quality.

Furthermore, in a third method step 130, the method comprises the cyclical determination of wear parameter data from the module data and weighted process parameter data, their summation to a cumulative wear parameter and storage in the data store 8 of the device 1 by means of the control unit 7 of the device 8.

In a fourth method step 140, an analysis and action recommendation is generated and stored by the control unit 7 of the device 1 in the data store 8 of the device 1 when the cumulative wear parameter exceeds a critical reference parameter stored in the data store 8 of the device 1.

If after the request made in the method step 140, the reference value and/or a value for a warning step is already exceeded, this leads to a fifth method step 150 with outputting of the stored analysis and action recommendations. If it is not reached, the method is continued at method step 120, to acquire further data.

The stored analysis and action recommendations can be output and/or visualised in a display device 15.

In this way, a forward-looking servicing is enabled in the sense of recommendations for monitoring or possibly the exchange of components of the individual modules 2, 3, 4, 5, 6, 13 and/or module components, such as for example, an extruder shaft respectively a screw shaft 10, a backflow check valve 11 or a plasticising cylinder 12 of the plasticising module 2 or an output nozzle or an output unit. Thereby, inter alia, conclusions regarding the loading on the mechanical components are possible.

Therein, the aim is, for example, to enable individualised servicing and/or servicing intervals for drive trains and motors of the plasticising module 2 or the mold module/object carrier module 6 by means of a correlation between process data and wear status of the modules 2, 6. Cyclical should be understood in this case to be the repeated discrete, that is for example, clock-driven or event-driven determination of the aforementioned wear parameter data.

The module data can contain, for example, the serial and material numbers of the modules 2, 3, 4, 5, 6, 13 and/or of module components, for example, of the extruder shaft and/or the screw shaft 10, of a backflow check valve 11 and/or of the plasticising cylinder 12 of the plasticising module 2. The module data can however also be, for example, a diameter of the screw shaft, the material from which a module component is produced, etc. These numbers can also be applied onto the respective module components, e.g. by lasers etc. The module data can be partially exchanged according to the respective equipping of the device and thus individualised according to the module 2, 3, 4, 5, 6, 13 respectively the module components used, in order for example to represent the respective use (injection moulding, extrusion output, droplet output, etc.) of the device accordingly.

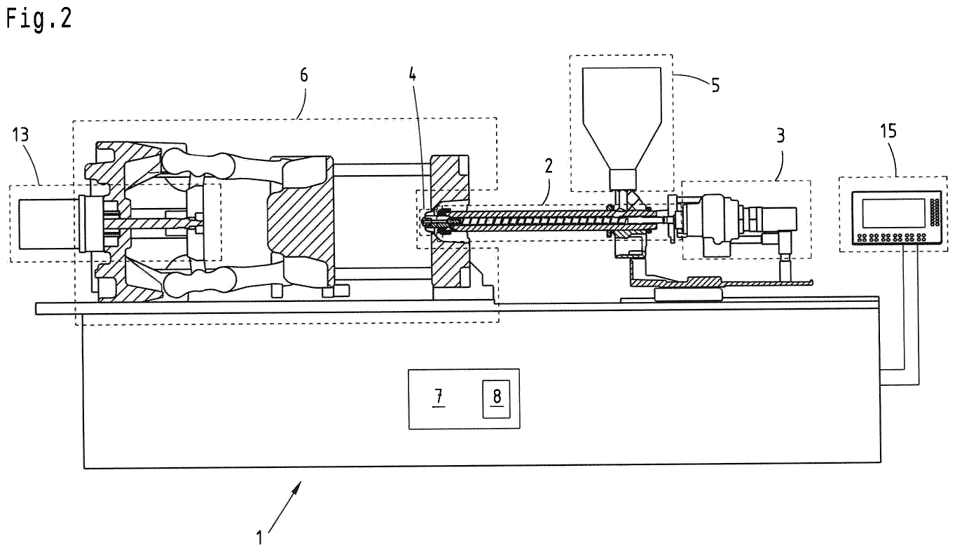

FIG. 2 shows a second embodiment of the device 1 with exchangeable modules 2, 3, 4, 5, 6, 13, which functions according to an injection moulding process and has the components described above that are needed for the method for control 7, 27, 37, 47, 57, 137, data storage 8, 28, 38, 48, 58, 138 and communication 9, 29, 39, 49, 59, 69, 139 and runs through all the method steps 110, 120, 130, 140, 150 described above that are needed for the method and is thus identical with the first embodiment except for the processing procedure.

The wear parameter data determined by means of the cyclical processing of the module data and weighted process parameter data and the accumulated wear parameters of the individual modules 2, 3, 4, 5, 6, 13 obtained therefrom can be output on a display device 15 as a history and/or visualised and set in relation to stored critical reference parameters. The display device 15 is a human-machine interface which can also be configured otherwise, and can also enable an interaction with an artificial intelligence over a suitable communication route.

The analysis and action recommendation generated from the data can also be output and/or visualised to a user of the device 1 on the display device 15. All the data can however also be exchanged within a network with different devices 1 for processing plastics and other plasticisable materials by means of a cyclical or continuous processing procedure and analysis and/or control systems. This network can be both a local network and also a global, for example cloud-based, network.

The process parameter data can be, for example, a counter value, a mean value, a maximum and minimum value, a cycle-weighted mean value, a work integral, an injecting pressure, a holding pressure, a back pressure, a torque, a rotary speed, a loading value, etc.

The method and/or the device 1 with the method therefore acquires the loading and the wear of all the components of the device 1, for example, the extruder shaft and/or the screw shaft 10, the backflow check valve 11 and the plasticising cylinder 12 of the plasticising module 2, the output nozzle of the material output module 4, conveying units of the material feed module 5, the mold/the object carrier 14 of the mold module/object carrier module 6, but also motors, transmissions, spindle systems, belts, bearings, etc. of the drive module 3, 13 of the plasticising module 2 and of the mold module/object carrier module 6.

Thereby, in an advantageous manner, the wear can be determined, for example, for a plasticising module 2, a drive module 3, a material output module 4, a material feed module 5 and a mold module/object carrier module 6.

Preferably, the communications interfaces 9, 29, 39, 49, 59, 69, 139 of the at least one module 2, 3, 4, 5, 6, 13 and the device 1 transfer the data wirelessly. Also possible are bus connections which connect the modules and the device to one another in a simple manner for communication. The connection between the individual nodes and/or communications interfaces 9, 29, 39, 49, 59, 69, 139 can be constructed by any suitable means. In principle, all the control units of the modules could be connected to the control unit 7 of the device 1 in a star configuration. Alternatively, they can all be connected in a line, in a ring or, as in FIG. 1, as a tree, or a mixture thereof, in communication connection to one another. In this regard, the topology and arrangement shown in FIG. 1 is not restrictive. Preferably, the connection takes place in real time with, for example, a cycle time, depending upon the bus, of 100 ms, 2 ms, 250 μs, although other cycle times are possible.

The control unit 7 of the device 1 which is advantageously in operative connection and in communication with the module components and/or the modules 2, 3, 4, 5, 6, 13 of the device 1 can be arranged either inside or outside the device 1. In particular, the control unit 7 of the device 1 can be connected by means of a network, for example, cloud-based.

Advantageously, the analysis and action recommendation and the process parameter data can be stored in an external data store 8. In particular, the external data store 8 can be linked by means of a network, for example cloud-based, in order thereby also to be able to implement on edge or cloud solutions better.

Preferably, from the module data and the weighted process parameter data, an equivalent stress of at least one of the module components can be ascertained and used as a wear parameter.

If required, the wear parameter data are converted into status variables and transferred into an input layer of a trained device for machine learning, wherein preferably the device for machine learning outputs the analysis and action recommendation.

As process parameter data, all data come into consideration that are suitable per se or in conjunction with other data or information to allow a corresponding evaluation, in particular, regarding wear. Such process parameter data can be, for example: a counter value, a mean value, a maximum and minimum value, a cycle-weighted mean value, a work integral, an injecting pressure, a holding pressure, a back pressure, a torque, a rotary speed, a loading value, an equivalent stress on an extruder shaft 10, in particular a screw shaft, and on at least one drive shaft, an equivalent stress which is ascertained from a loading during injection, during the holding pressure or during the dosing, a screw travel, a closing force of the mold 14, a target and actual position as well as a target and actual speed of the mold 14 or the object carrier 14, a target and actual pressure of the plasticising module 2, a droplet size or a mass volume of the material output module 4, a number of fibre strands fed in, an elastic constant of the fibre strands, a density distribution of the fibre strands, a material characteristic value of the currently processed material or of a plasticisable material of the material feed module 5, time, time periods, time sequences or an energy usage value of a heating system or mechanism.

Preferably, a handling module with a control unit on the material feed module 5 for handling the plasticisable material or a handling module with a control unit on the mold module/object carrier module 6 for handling a plasticisable material and components can be used. I.e. with the handling module, for example, in an injection moulding process, material possibly protruding on the mold module could be skimmed off or the finished component could be removed from the mold module respectively in an additive method, the finished component could be removed from the object carrier module.

Ideally, in relatively large injection moulding plants, data from similar or identical machines on which similar or identical processes run with materials of a similar or identical material class can preferably be “gathered together”. This collecting “on edge” and evaluating of all the data enables still better algorithms in the context of federated learning and thus a still better and more reliable model for evaluating and predicting wear in individual, or a plurality of, modules. The operator of plants can thus roll out an algorithm generated in this way from his “model factory” to other production locations and obtains the same good product quality worldwide with simultaneous knowledge protection, since he is placed in the position, where needed, of counteracting early a wear-related quality loss in the components to be produced.

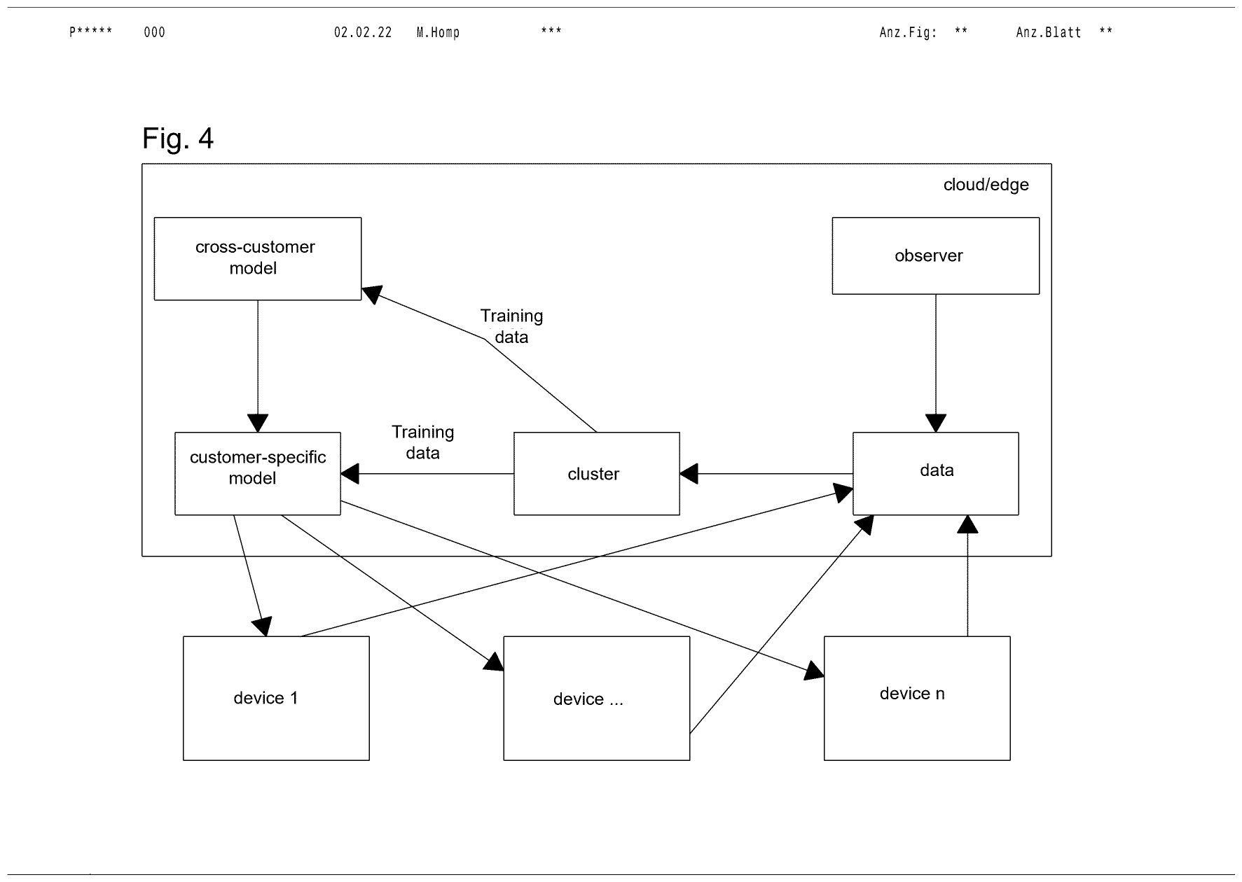

This will now be described in greater detail referring to the diagram in FIG. 4. The upper part of the Figure shows a cloud/edge solution. For this purpose, according to FIG. 4, in particular, the following data are evaluated:
Module data and/or
Weighted process parameter data and/or
Wear parameter data and/or
Analysis and action recommendations.

These data are gathered from device 1, . . . to device n and clustered by an observer, for example, according to identical or similar machine configurations, identical processes and/or identical or similar materials that are to be processed. These clusters are evaluated and form training data for a model belonging to the customer, in particular for evaluating and predicting wear, in order, by way of federated learning, also to operate other machines, for example, in the customer's machine park, with the results of the evaluation. In particular, the model can output analysis and action recommendations in advance, for example, where appropriate, given knowledge of the machine configuration also to recommend to a user a more suitable feed screw when an abrasive material is used in injection moulding operation.

The machine manufacturer also has an interest in the machine operator providing at least extracts of the “on edge”-generated algorithms into the cloud of the machine manufacturer. The machine manufacturer collects the extracts of the algorithms, i.e. the content that is released by the customer, from as many machine operators (customers) as possible, compares them and thereby enhances the generation of a cross-customer model (deep learning).

The advantages set out with regard to the method apply also in a device 1 for processing plastics and other plasticisable materials, provided that the device 1 is equipped, configured and constructed to carry out the method accordingly.

The advantages of the method also arise from the use of a computer program product with a program code which is stored on a computer-readable medium so that the method can be carried out using the program code.

1.-12. (canceled)

13. Method for determining the wear on at least one exchangeable module of a device for processing plastics and other plasticisable materials by a cyclical or continuous processing procedure and for the output of wear-based analysis and action recommendations, wherein the device comprises the at least one exchangeable module and wherein the device and the at least one exchangeable module each comprise a control unit and communications interfaces between the control units, comprising the steps:
providing module data, which comprise information regarding module components used, in a data store of the at least one module and sending the module data by means of the control unit of the at least one module to the control unit of the device for storage in a data store of the device,
cyclical acquisition and storing of process parameter data of process parameters of the device, said process parameter data comprising at least one of process-specific information and material-specific information, in the data store of the at least one module during the processing procedure by the control unit of the at least one module,
weighting the process parameter data with at least one of a capacity utilisation value and a cycle count and an operating duration of the module by the control unit of the at least one module,
storing the weighted process parameter data in the data store of the at least one module and sending the weighted process parameter data to the control unit of the device for storage in a data store of the device by means of the control unit of the at least one module,
cyclical determination of wear parameter data regarding the at least one exchangeable module from the module data and the weighted process parameter data, their summation to a cumulative wear parameter and storage in the data store of the device by means of the control unit of the device,
generating an analysis and action recommendation by the control unit of the device when the cumulative wear parameter exceeds a critical reference parameter stored in the data store of the device.

14. Method according to claim 13, wherein the wear is determined for at least one of the modules comprising a plasticising module, a drive module, a material output module, a material feed module and a mold module/object carrier module.

15. Method according to claim 13, wherein the analysis and action recommendation is output or visualised or output and visualised.

16. Method according to claim 13, wherein the analysis and action recommendation is stored in in the data store of the device.

17. Method according to claim 13, wherein the communications interfaces of the at least one module and of the device transfer the data wirelessly.

18. Method according to claim 13, wherein from the module data and the weighted process parameter data, an equivalent stress of at least one of the module components is ascertained and used as a wear parameter datum.

19. Method according to claim 13, wherein the wear parameter data are converted into status variables and transferred into an input layer of a trained device for machine learning.

20. Method according to claim 18, wherein the device for machine learning outputs the analysis and action recommendation.

21. Method according to claim 14, wherein as process parameter data at least one of the following process parameter data are included and used: a counter value, an injecting pressure, a holding pressure, a back pressure, a torque, a rotary speed, a loading value, an equivalent stress on an extruder shaft, in particular a screw shaft, and/or on at least a drive shaft, a screw travel, a closing force of the mold, a target and actual position as well as a target and actual speed of the mold or the object carrier, a target and actual pressure of the plasticising module, a droplet size or a mass volume of the material output module, a number of fibre strands fed in, elastic constants of the fibre strands, a density distribution of the fibre strands, material characteristic values of the currently processed material or of a plasticisable material of the material feed module, time, time periods, time sequences or an energy usage value of a heating system or mechanism.

22. Method according to claim 14, wherein a handling module with a control unit on the material feed module is used for handling the plasticisable material.

23. Method according to claim 14, wherein a handling module with a control unit on the mold module/object carrier module is used for handling a plasticised material and components.

24. Method according to claim 13, wherein it is carried out on a plurality of machines and at least from a part of the following data, comprising
module data
weighted process parameter data
wear parameter data
analysis and action recommendations
according to at least one of identical or similar machine configurations, identical processes or identical or similar materials that are to be processed, clusters are formed and these clusters are evaluated in order to operate federated learning machines with the results of the evaluation.

25. Method according to claim 23, comprising the steps:
comparing the results of the evaluation at least partially with one another and ascertaining comparison results,
enhancing the data required for the method, comprising at least one of
weighted process parameter data
wear parameter data
analysis and action recommendations
on the basis of the comparison results.

26. Method according to claim 24, wherein the comparing the results of the evaluation is cloud-based

27. Device for processing plasticisable materials by way of a cyclical or continuous processing procedure which configured to carry out the method for determining the wear of at least one module of the device according to claim 13.

28. Computer program product with a program code which is stored on a computer-readable medium, for carrying out a method according to claim 13.
